(19) United States
(12) Patent Application Publication
(10) Pub. No.: US 2012/0210399 A1
(43) Pub. Date: Aug. 16, 2012

(54) LOCATION-ENABLED ACCESS CONTROL LISTS FOR REAL-WORLD DEVICES

(75) Inventor: Kenneth Jennings, Raleigh, NC (US)

(73) Assignee: WALDECK TECHNOLOGY, LLC, Wilmington, DE (US)

(21) Appl. No.: 13/398,068

(22) Filed: Feb. 16, 2012

Related U.S. Application Data
(60) Provisional application No. 61/443,401, filed on Feb. 16, 2011.

(51) Int. Cl. G06F 21/00

(52) U.S. Cl. 726/4

(57) ABSTRACT

Systems and methods are disclosed for providing an accessor with access to an accessed device through a network. In one embodiment, location-based access control rights of the accessor to the accessed device are obtained. The location-based access control rights define at least one location criterion such that access rights are to be granted to the accessor for the accessed device when a location of the accessor complies with one or more of the at least one location criterion. Upon determining that the location of the accessor device complies with the at least one location criterion, the accessor device of the accessor is granted access to the accessed device through the network. In this manner, an administrator of the accessed device can regulate from where the accessor can access the accessor device.

### RELATED APPLICATIONS

This application claims the benefit of provisional patent application Ser. No. 61/443,401, filed Feb. 16, 2011, the disclosure of which is hereby incorporated herein by reference in its entirety.

### FIELD OF THE DISCLOSURE

The disclosure relates generally to systems and methods for providing an accessor with access to an accessed device through a network.

### BACKGROUND

As more and more devices become internet-enabled, users are given greater and greater capacity to control these internet-enabled devices through a network. For example, a user may use their mobile communication device to control a remote device, such as a television cable box, through the network when the user is not at home. The user may enter user credentials into the mobile communication device and, upon verification of the user credentials, the user may be provided with access to the remote device. Unfortunately, if the user desires for another user to be able to control the remote device, the user generally has to provide the other user with the user's private credentials. Consequently, once the other user has finished using the remote device for a desired purpose, the user may have to set up new user credentials in order to maintain private access to the remote device. Additionally, the user may also desire to restrict access so that the other user can only access the remote device when the other user is near the remote device. For instance, if the remote device is a home security system, the user may want to allow the other user to disable an alarm when the other user is near the home. However, the home security system generally has no manner of determining the location of the other user relative to the home or itself. As such, the user is forced to provide the other user with the user's private credentials in order for the other user to disable the alarm.

Accordingly, what are needed are systems and methods that allow a user to be able to more effectively restrict access by others to the remote device.

### SUMMARY

The disclosure relates generally to systems and methods for providing an accessor with access to an accessed device through a network. To define the manner in which the accessor can access the accessed device, an administrator creates location-based access control rights. The location-based access control rights define at least one location criterion such that access rights of the accessor are to be granted when a location of the accessor complies with the at least one location criterion. Accordingly, the administrator can regulate from where the accessor can access the accessed device. The accessor may control the accessed device through the network from an accessor device assigned to the accessor.

According to one embodiment of a method for providing the accessor with access to the accessed device, location-based access control rights of the accessor to the accessed device are obtained. In addition, location data that identifies the location of the accessor device is also obtained. Based on the location data, a server computer on the network may determine whether the location of the accessor device complies with the at least one location criterion defined by the location-based access control rights of the accessor. If the location of the accessor does not comply with the at least one location criterion, the accessor is not granted access to the accessed device. However, upon determining that the location of the accessor device does comply with the at least one location criterion, the accessor device is granted access to the accessed device. In this manner, the administrator can manage the access rights granted to the accessor and from where those access rights can be exercised.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 illustrates one embodiment of a system that may be implemented to provide one or more accessors with access to accessed devices through a network.

FIG. 2 illustrates exemplary procedures that may be implemented to provide an accessor with access to an accessed device upon determining that the location of an accessor device assigned to the accessor complies with at least one location criterion.

FIG. 3 illustrates a flow diagram that illustrates exemplary procedures related to an accessor setting up an accessor account and an administrator of an accessed device setting up an administrator account with a server computer.

FIG. 4 illustrates exemplary procedures related to the accessor and the administrator logging into the server computer along with an exemplary procedure in which the administrator provides location-based access control rights to the accessor so that the accessor can access the accessed device once the accessor complies with at least one location criterion defined by the location-based access control rights.

FIG. 5 is a flow chart that illustrates exemplary procedures that may be implemented by a server computer when the accessor has location-based access control rights to more than one accessed device.

FIG. 6 is a flow diagram that illustrates exemplary procedures related an embodiment of granting an accessor device access to an accessed device.

FIG. 7 is a flow diagram that illustrates exemplary procedures related to another embodiment of granting the accessor device access to the accessed device.

FIG. 8 illustrates one embodiment of a server computer shown in FIG. 1.

FIG. 9 illustrates one embodiment of a user device that may be utilized as an administrator device, an accessor device, an accessed device, and/or as a location-enabled accessed device shown in FIG. 1.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

This disclosure relates to systems and methods of providing an accessor with access to an accessed device through a network. An accessed device may be any type of user device that can be controlled by another user device through a network. The accessed device thus may be a mobile communication device, such as a cellular phone, a personal computer, a laptop computer, a home security system, a vehicle protection system, a personal navigation device, a cable television box, a tablet, and/or the like. An administrator is a user that has the authority to manage access to an accessed device. The accessed device may be assigned to the administrator and/or the administrator may simply have been granted authority to control access to the accessed device. For example, the owner of a home security system may be an administrator of the home security system. In another example, family members within a home may all be designated as administrators of a cable television box or a personal computer.

An accessor refers to the user that is provided access to the accessed device through the network using another device, which is referred to as the accessor device. The accessor device may be any type of user device that is location enabled and is capable of controlling the accessed device through a network. The accessor device may thus be a mobile communication device, a personal navigation device, a tablet, a laptop, and/or the like. It should be noted that the accessor may have a plurality of accessor devices that have been assigned to the accessor. Either through direct interaction with the accessed device or through interaction with an administrator device, the administrator may create location-based access control rights defining at least one location criterion so that access rights are granted to the accessor when a location of the accessor satisfies the at least one location criterion. Accordingly, the accessor may be provided with access to the accessed device in accordance with the accessor's location.

Utilizing the systems and methods described in this disclosure, embodiments may be designed to allow the administrator to provide the accessor access to the accessed device for specific purposes. For example, the owner of a home security system may desire for a guest to be able to disable the home security while the guest is visiting a home of the home owner. Although the home owner desires to allow the guest to disable the home security system and enter the home during the duration of the guest's visit, the home owner may not want to provide the guest with a personal security code for the home security system. The home owner through an administrator device may create a location-based access control right that provides the accessor with access to the home security system when the guest is near the home. However, once the guest visit is over, the home owner may remove the location-based access control right or the location-based control right may automatically terminate. It should be noted that different implementations of the embodiments described herein may be utilized to allow the accessor access to accessed devices for a myriad of different purposes which may depend on the functionality of the accessed device, the functionality of the accessor device, and/or the types of networks being utilized.

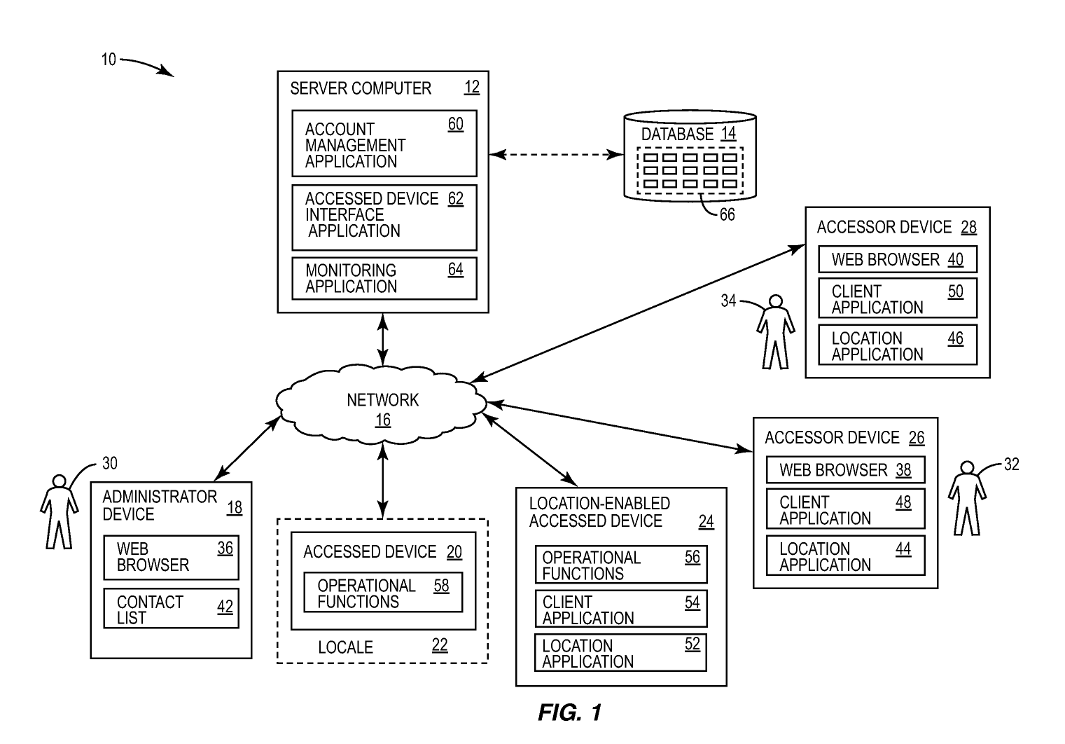

FIG. 1 illustrates a system 10 according to one embodiment of the present disclosure. Prior to discussing the details of different implementations of the system 10, a general description of the components of the system 10 is provided. In this embodiment, the system 10 includes a server computer 12, a database 14 operably associated with the server computer 12, a network 16, an administrator device 18, an accessed device 20 at a locale 22, a location-enabled accessed device 24, an accessor device 26, and another accessor device 28. The administrator device 18, the accessed device 20, the location-enabled accessed device 24, the accessor device 26, and the accessor device 28 may be commutatively coupled to the server computer 12 through the network 16. In this embodiment, the administrator device 18, the accessed device 20, and the location-enabled accessed device 24 are each assigned to an administrator 30. The accessor device 26 has been assigned to accessor 32 and the accessor device 28 has been assigned to accessor 34.

While the administrator 30 shown in FIG. 1 is the administrator of the accessed device 20 and the location-enabled accessed device 24, the administrator 30 may be the administrator of any number of one or more accessed devices that are communicatively coupled to the network 16. For example, the administrator 30 may be an administrator for any number of accessed devices like accessed device 20 at a locale 22 and/or any number of accessed devices at different locales. Similarly, any number of location-enabled accessed devices, like the location-enabled accessed device 24 may be assigned to the administrator 30. In addition, while only a single administrator 30 is shown in FIG. 1, there may be any number of administrators, like the administrator 30, with any number of accessed devices communicatively coupled to the network 16. Furthermore, implementations of the system 10 may have any number of accessor devices, like accessor device 26 and accessor device 28, assigned to any number of accessors, like accessor 32 and accessor 34.

With regards to the network 16, the network 16 may be any type of network and may include any number of different types of networks. For example, the network 16 may include a distributed public network such as the Internet, one or more local area networks (LAN), one or more mobile communications networks, circuit switch networks, packet switch networks, personal area networks (PAN), and/or the like. If the network 16 includes various types of networks, the network may include gateways, and/or the like, to provide communication between the different networks. Also, the network 16 may include wired components, wireless components, or both wired and wireless components.

The administrator device 18, the accessed device 20, the location-enabled accessed device 24, the accessor devices 26, 28, and the server computer 12 may be connected to the network 16 through any number of various communication services that may be provided by the network 16. For example, the administrator device 18, the accessed device 20, the location-enabled accessed device 24, the accessor devices 26, 28, and the server computer 12 may connect to the network 16 through Ethernet connections, wireless local area connections (e.g., Wi-Fi connections), wireless telecommunications connections (e.g., 3G or 4G telecommunications such as GSM, LTE, W-CDMA, or WiMax connections) and/or the like. In addition, near field technologies such as IEEE 802.11 networking services, Bluetooth networking services, Zigbee networking services, Z-Wave networking services, Infrared Data Association networking services, mobile ad-hoc networking services, and/or the like may be utilized to connect the devices to the network 16.

In the embodiment shown in FIG. 1, the administrator device 18 and the accessor devices 26, 28 are mobile communication devices. Some exemplary mobile communication devices that may be utilized as the administrator device 18 and accessor devices 26, 28 are mobile smart phones, portable media player devices, mobile gaming devices, tablets, handheld computers, laptops, and/or the like. The administrator device 18, the accessor device 26, and the accessor device 28 shown in FIG. 1 each include a web browser 36, 38, and 40 respectively. The web browsers 36, 38, and 40 are operable to allow the administrator device 18, the accessor device 26, and the accessor device 28 to interact with other devices on the network 16. For example, the web browser 36, 38, and 40 allow the administrator 30 and accessor 32, 34 to register and log-in with the server computer 12. Alternatively, the administrator device 18, the accessor device 26, and the accessor device 28 may utilize any other type of program that allows these devices to interact with the server computer 12.

The administrator device 18 may store a contact list 42 that includes information regarding contacts of the administrator 30. In this example, it is assumed that the accessor 32 and the accessor 34 are contacts of the administrator 30 and thus the contact list 42 may include user IDs identifying the accessor 32, 34, MAC addresses of the accessor device 26 and the accessor device 28, telephone numbers, email addresses, social networking information, and/or the like. The contact list 42 may be utilized as a source of information so that the administrator can select contacts, such as accessor 32 and accessor 34, when providing location-based access control rights for the accessed devices 20, 24.

The accessor devices 26, 28 are each location-enabled devices meaning that the accessor devices are capable of retrieving location data that identifies a location of the accessor device 26, 28. This capability is provided to the accessor device 26 and the accessor device 28 by location application 44 and location application 46, respectively. The location applications 44, 46 may be mapping applications that provide the location data as triangulation data that identifies the location of the accessor device 26, 28. On the other hand, in other embodiments, the accessor device 26, 28 may include a GPS receiver. The accessor device 26 and the accessor device 28 also each have a client application 48, 50, respectively and each client application 48, 50 is configured to report the location data identifying the location of the particular accessor device 26, 28 to the server computer 12. The client applications 48, 50 may be initiated when the accessor 32, 34 logs into the server computer 12 through the accessor devices 26, 28. In this manner, the location of the accessor device 26, 28 assigned to the particular accessor 32, 34 can be assumed to be the location of that particular accessor 32, 34.

With regards to the location-enabled accessed device 24 in FIG. 1, the location-enabled accessed device 24 also includes a location application 52 that allows the location-enabled accessed device to obtain location data that identifies the location of the location-enabled accessed device 24. In other embodiments, a GPS receiver may also be utilized. While the location-enabled accessed device 24 may or may not be a mobile communications device, the location-enabled accessed device 24 is assumed to be mobile. For example, the location-enabled accessed device 24 may be a mobile communication device, a vehicle security system, a personal navigation device mounted on a vehicle, a digital radio system mounted on a vehicle, and/or the like. The client application 54 reports the location data that identifies the location of the location-enabled accessed device 24 to the server computer 12.

In addition, the location-enabled accessed device 24 has a plurality of operational functions 56. Each operational function 56 may be provided by hardware and/or software that provide the location-enabled accessed device 24 some type of designed functionality. Of course, the operational functions 56 provided by a particular embodiment of the location-enabled accessed device 24 vary in accordance with its operational characteristics. For example, if the location-enabled accessed device 24 is a vehicle security system, the vehicle security system may have the operational functions of enabling a vehicle alarm and disabling the vehicle alarm. A more complex location-enabled accessed device 24, such as a personal navigation device, may have various operational functions such as the presentation of a map browser, the ability to implement a travel destination session, programs for adjusting the settings of the map browser, and/or the like.

With regards to the accessed device 20, the accessed device 20 is located at the locale 22. The locale 22 may be any type of geographical region or geographic structure that is identifiable. For example, the locale 22 may be a home, an address, a work location, a building, and/or the like. The accessed device 20 at the locale 22 does not have to be location-enabled because the accessed device 20 may be assumed to be at the locale 22. For example, if the locale 22 is a home, the accessed device 20 may be a personal computer, a home security device, a cable television box, a local area wireless router, a home gaming system, and/or the like. The accessed device 20 may also provide a plurality of operational functions 58. The operational functions 58 provided by the accessed device 20 may depend on the operational characteristics of the particular embodiment of the accessed device 20 being utilized.

As discussed above, the administrator 30 may provide location-based access control rights to the accessed device 20 and the location-enabled accessed device 24 to accessors, such as the accessor 32 or the accessor 34. The administrator 30 may provide these location-based access control rights when logged into the server computer 12. With regards to the accessor 32, the location-based access control rights of the accessor 32 to the location-enabled accessed device 24 define at least one location criterion such that access rights are to be granted to the accessor 32 for the location-enabled accessed device 24 when the location of the accessor 32 satisfies at least one location criterion. On the other hand, the location-based access control rights of the accessor 34 to the accessed device 20 define access rights that are to be granted to the accessor 34 for the accessed device 20 when a location of the accessor 34 satisfies at least one location criterion. Examples of location criterion may be a location, a street address, a radial parameter, various perimeter parameters that define a symmetrical or unsymmetrical perimeter, and/or the like.

FIG. 1 also illustrates one embodiment of the server computer 12. The server computer 12 is operable to implement an account management application 60, an accessed device interface application 62, and a monitoring application 64. Note that in this embodiment, a single server computer 12 provides the account management application 60, the accessed device interface application 62, and the monitoring application 64. Also, in this embodiment, the server computer 12 operates directly with the database 14, which is also located at the same network location as the server computer 12. This is not necessarily the case. In alternative embodiments, some or all of the applications may be provided by different server computers operating cooperatively for example, in one or more data centers. The server computers may be located either at the same network locations or at various different network locations distributed throughout the network 16. Each server computer may interface with any number of databases, like the database 14, either directly or through the network 16. The account management application 60 of the server computer 12 is operable to manage access to the server computer 12 and to accounts stored through database records 66 on the database 14.

To provide access to the server computer 12, the account management application 60 may execute a log-in process that authenticates the administrator 30, the accessor 32, and/or the accessor 34 with the server computer 12. For example, the log-in process may be performed using credentials such as a username and password entered by the administrator 30, the accessor 32, and the accessor 34 using the web browsers 36, 38, and 40 which are sent to the account management application 60. The accessed device interface application 62 allows the server computer 12 to communicate with the accessed devices 20, 24.

An accessed device interface application 62 may also be operable to send server commands to the accessed device 20 and location-enabled accessed device 24. These server commands may be configured to cause the accessed devices 20, 24 to implement the operational functions 56 and operational functions 58. Since embodiments of the accessed device 20 and location-enabled accessed device 24 may have any number of operational characteristics, the accessed device interface application 62 may be programmable to interface with any number of different types of accessed devices. Parameters for interfacing with any particular type of accessed device may be stored in one or more of the database records or may be obtained through device protocol procedures between the server computer 12 and the particular accessed device.

An administrator may have an administrator account and under the administrator account may access control records that include the location-based access control rights of accessors to accessed devices. For example, the administrator 30 may have an administrator account and under this administrator account there may be an access control record that includes the location-based access control rights of the accessor 32 to the accessed device 20 and the location-based access control rights of the accessor 34 to the accessed device 20. Similarly, there may be another access control record under the account of the administrator 30 that includes the location-based access control rights of the accessor 32 to the location-enabled accessed device 24 and the location-based access control rights of the accessor 34 to the location-enabled accessed device 24. Other data that may be under the administrator account of the administrator 30 is a user ID and password of the administrator, email information of the administrator, device identification information, or addresses for administrator devices such as administrator device 18, device identification information or addresses of the accessed device 20 and location-enabled accessed device 24, protocol information, device commands for the accessed device 20 and location-enabled accessed device 24, and/or the like. This information, along with the access control records, may be stored as or within the database records 66. A monitoring application 64 implemented by the server computer is operable to receive location data from the client applications 48, 50, and 54. The monitoring application 64 may also be operable to determine when location criteria for location-based access control rights have been satisfied.

There may also be accessor accounts stored by the database 14. Accessor records may be stored under each of these accessor accounts. The accessor records may include record links to the access control records that include location-based accessed control rights for the accessor. For example, the accessor record of the accessor 32 may include a record link to the access control record of the accessed device 20 if the administrator 30 has provided the accessor 32 with location-based accessed control rights to the accessed device 20. Another record link may be included in the accessor record of the accessor 32 if the administrator 30 provides the accessor 32 with location-based accessed control rights to the location-enabled accessed device 24. On the other hand, under the accessor account of the accessor 34, there may be another accessor record that includes a record link to the access control record of the accessed device 20, if the administrator 30 has provided the accessor 34 with location-based accessed control rights to the accessed device 20. Similarly, this accessor record may include another record link to the accessor control record of the location-enabled accessed device 24, if the administrator 30 has provided the accessor 34 with location-based accessed control rights to the location-enabled accessed device 24. In this manner, the monitoring application 64 may determine which location data is relevant to the location-based accessed control rights for the accessed devices 20, 24. Other information that may be stored under the accessor account are a username of the accessor 32, 34, a password of the accessor 32, 34, device identification information or protocol information of the accessor device 26, 28, and/or the like. This information, along with the accessor record, may be stored as or within the database records 66.

In the illustrated example, the database 14 is programmed to store all of the given information for the administrator accounts and accessor accounts. The database 14 may maintain database records 66 in accordance with the database tables or objects and the information for the administrator account or accessor account may or may not be at least partially distributed among various database records 66. Accordingly, the database records 66 may have pointers (or pointer-to-pointer) that point to memory locations associated with other database records 66 that actually store the information for a particular administrator account or accessor account. In alternative embodiments, various different databases may store the information of an accessor record or access control record. The administrator accounts and accessor accounts may include a database link to the database record of another database in order to find the information.

It should be noted that embodiments of the different devices, such as the administrator device 18, accessed device 20, location-enabled accessed device 24, accessor device 26, accessor device 28, and server computer 12, are described throughout this disclosure as using software applications to provide certain functionality. As is apparent to one of ordinary skill in the art, any system that can be implemented with software applications has a hardware circuit analog that utilizes hardware circuits specifically configured to provide the same functionality as the software application. Accordingly this disclosure does not intend to limit the devices described herein to the use of software applications and general purpose hardware. Instead the systems and devices may be implemented using software applications, hardware circuits, or some combination of both software applications and hardware circuits. All of these implementations are considered to be in the scope of this disclosure.

Also the software applications described in this disclosure are described as being distinct software applications. This is done for the purposes of clarity but it may or may not necessarily be the case. Alternatively, the software applications may be partially or fully integrated with one another and/or may be partially or fully integrated as part of one or more other generalized software applications. These and other alternatives for providing the functionality of the software applications would be apparent to one of ordinary skill in the art in light of this disclosure and are considered within the scope of this disclosure.

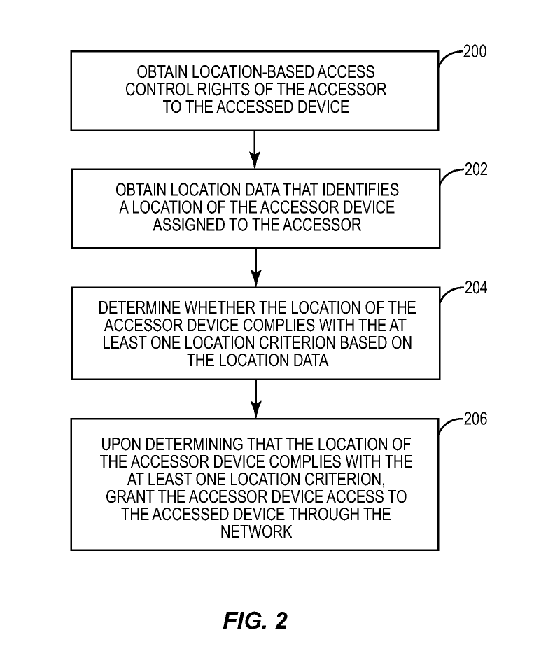

Referring now to FIGS. 1 and 2, FIG. 2 illustrates one embodiment of exemplarily procedures that may be implemented by the server computer 12 to provide the accessor 32, 34 with access to one of the accessed devices 26, 28 through the network 16. These procedures are described assuming that the accessor 32 is the accessor and that the accessed device is the accessed device 20. However, it should be noted that the procedures are equally applicable for the accessor 34 and the location-enabled accessed device 24. To begin, the server computer 12 obtains location-based access control rights of the accessor 32 to the accessed device 20 (procedure 200). The location-based access control rights of the accessor 32 may be obtained from the access control record of the accessed device 20, or alternatively and additionally, the location-based access control rights may be received by the server computer 12 from the administrator device 18 as a result of the administrator 30 creating the location-based access control rights of the accessor 32 through the administrator device 18. The location-based access control rights define at least one location criterion such that access rights are to be granted to the accessor 32 for the accessed device 20 when a location of the accessor 32 satisfies the at least one location criterion. The at least one location criterion may include any number of one or more location criteria that need to be satisfied by the location of the accessor 32. For example, in one embodiment the location criterion is a radial distance parameter that indicates a radial distance from the locale 22. The location of the accessor 32 satisfies the radial distance parameter when the location of the accessor 32 indicates that the accessor 32 is within the radial distance from the locale 22.

To provide another example, the location-based access control rights of the accessor 34 to the location-enabled accessed device 24 can also be obtained by the server computer 12. In this example, the location criterion may be a radial distance parameter that indicates a radial distance from the location-enabled accessed device 24. The location of the accessor 34 satisfies the radial distance parameter when the location of the accessor is within the radial distance of the location of the location-enabled accessed device 24. In other embodiments, location criteria may define one or more dimensional parameters that define any type of symmetrical or asymmetrical perimeter, may identify a geographic region or structure or a type of geographic region or structure, indicate a street address, and/or the like.

Once the server computer 12 determines that the accessor device 28 complies with the at least one location criterion defined by the location-based access control rights, the location-based access control rights of the accessor 32 may in and of themselves provide the accessor 32 unlimited access to all of the operational functions 58 of the accessed device 20. Similarly, the location-based access control rights in and of themselves may provide the accessor 34 unlimited access to all of the operational function 56 of the location-enabled accessed device 24. On the other hand, the location-based access control rights of the accessor 32 may also define one or more access permissions that provide access to a subset of one or more of the plurality of the operational functions 58. Analogously, the location-based access control rights of the accessor 34 to the location-enabled accessed device 24 may define one or more access permissions that provide access to a subset of the operational functions 56 of the location-enabled accessed device 24. For example, if the location-enabled accessed device 24 is a personal navigation device mounted on a vehicle, the access permissions may allow the accessor to initiate a pre-programmed travel session to the administrator 30's home but not allow other types of travel sessions or map browsing to be implemented by the accessor 34. On the other hand, the location-based access control rights of the accessor 32 and 34 may further define one or more access permissions that define a time period which temporarily limit the access rights of the accessor 32, 34 to the respective accessed device 20, 24. In this manner, the location-based access control rights to the accessed devices 20, 24 may be automatically terminated after the duration of the time period.

Next, the server computer 12 obtains location data that identifies a location of the accessor device 26 assigned to the accessor 32 (procedure 202). The location data may have been reported by the client application 48 to the monitoring application 64 on the server computer 12. When the accessor 32 has logged in to the server computer 12 through the web browser 38 of accessor device 26, the location of the accessor device 26 may be presumed to be the location of the accessor 32. Thus, the location data that identifies the location of the accessor device 26 also identifies the location of the accessor 32. The server computer 12 may then determine whether the location of the accessor device complies with the at least one location criterion based on the location data (procedure 204). Upon determining that the location of the accessor device complies with the at least one location criterion, the server computer 12 grants the accessor device 26 access to the accessed device 20 through the network 16 (procedure 206). If the location-based access control rights define one or more access permissions that provide access to a subset of the plurality of operational functions 58, then the accessor device 26 is granted access to the accessed device 20 in accordance to the access permissions so that the accessor device 26 can only access the subset of the operational functions 58. Alternatively or additionally, if the location-based access control rights of the accessor 32 include one or more access permissions that define a time period that temporarily limits the access rights of the accessor 32 to the accessed device 20, the accessor device 26 is granted access to the accessed device 20 only for the duration of the time period.

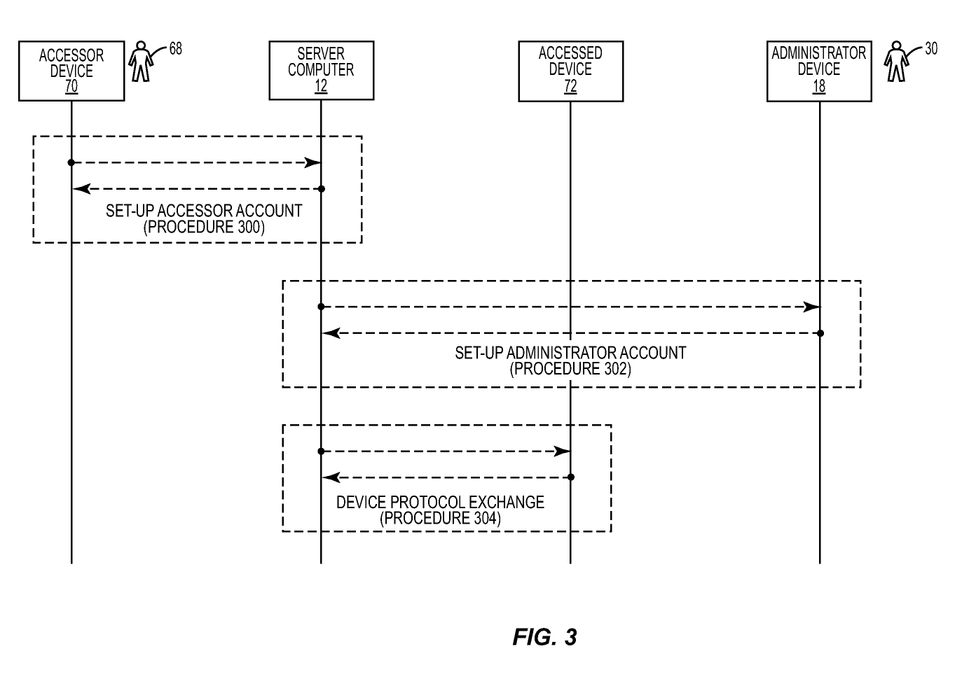

Referring now to FIG. 3, FIG. 3 illustrates one embodiment of a flow diagram that illustrates procedures for setting up an accessor account of an accessor 68 associated with an accessor device 70 and an administrator account of the administrator 30 associated with the administrator device 18. The accessor 68 may be either the accessor 32 or the accessor 34 shown in FIG. 1 and the accessor device 70 may be either the accessor device 26 or the accessor device 28 shown in FIG. 1. An accessed device 72 has been assigned to the administrator 30. The accessed device 72 may be either the accessed device 20 or the location-enabled accessed device 24 shown in FIG. 1.

As shown in FIG. 3, the accessor 68 sets up an accessor account (procedure 300) with the server computer 12 through the accessor device 70.

Alternatively, the accessor 68 may set up the accessor account with the server computer 12 through some other user device that can communicate with the server computer 12. During the set up of the accessor account, a username and password may be provided and the accessor record for the accessor 68 may be initiated. Also, the server computer 12 and the accessor device 70 may exchange device information that identifies and/or allows for communications between the devices.

The administrator 30 may also set up an administrator account with the server computer 12 (procedure 302). To set up the administrator account, a username and password may be provided for the administrator 30. In addition, information identifying administrator devices, such as administrator device 18, and/or the like, may also be provided. The administrator 30 may also provide information for accessed devices, such accessed device 72, which may be accessed by accessors, such as the accessor 68.

In the embodiment shown in FIG. 3, the server computer 12 and the accessed device 72 perform a device protocol exchange (procedure 304). During the device protocol exchange, the server computer 12 may initiate an access control record for the accessed device 72 and may obtain information regarding the operational functions of the accessed device 72, and/or may establish validation procedures so that the server computer 12 can be validated by the accessed device 72. In one example, the server computer 12 may not have information regarding the particular make of the accessed device 72. During the device protocol exchange, the server computer 12 may be operable to determine commands for the operational functions of the accessed device 72, formatting procedures for the commands of the accessed device 72, and/or formatting information regarding input and output messages to and from the accessed device 72. Alternatively or additionally, the database records 66 in the database 14 (shown in FIG. 1) may include pre-defined information regarding a variety of different makes for the accessed devices. If the accessed device 72 were of one of these makes, the server computer 12 may simply obtain the appropriate information from the database 14 in order to determine commands, formatting procedures, and/or formatting for input and output messages to and from the accessed device 72.

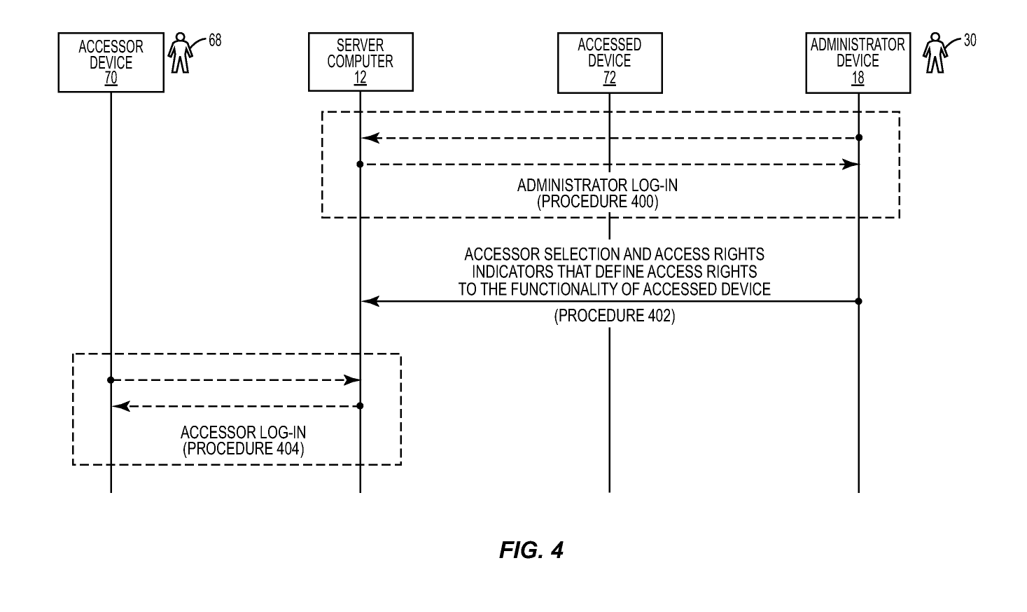

FIG. 4 illustrates a flow diagram of procedures that may be implemented in order to implement the procedures discussed above in FIG. 2. In this embodiment, an administrator log-in is performed (procedure 400). To do this, the administrator device 18 may present a log-in screen to the administrator 30 through the web browser 36 (shown in FIG. 1) or through some other application for interfacing with the server computer 12. The administrator 30 may input a username and password into the web browser 36 which are then transmitted to the server computer 12. If the appropriate username and password have been entered, the server computer 12 grants the administrator device 18 with access to the administrator account of the administrator 30. Once the administrator device 18 has access to the administrator account, one or more accessors, such as accessor 68, may be given location-based access rights to the accessed device 72. In this embodiment, the administrator 30 desires to give the accessor 68 location-based access rights. The administrator 30 may look up the accessor 68 on the contact list 42 (shown in FIG. 1). The administrator device 18 may present the contact list to the administrator as selectable icons for each of the contacts. After selection of one of the icons, the administrator device 18 receives the accessor selection and the administrator 30 may be prompted to define the location-based access rights of the accessor 68.

Subsequently, the accessor selection and the location-based access rights of the accessor 68 are received by the server computer 12 (procedure 402). In response, the server computer 12 updates the access control record of the accessed device 72 so the location-based access rights of the accessor 68 are included within the access control record. In this manner, the administrator 30 may define location-based access rights for any desired accessor 68 to the accessed device 72. It should be noted that any number of accessed devices, such as accessed device 72, may be assigned to the administrator 30. Under the administrator account of the administrator 30, there may be various access control records for these different accessed devices. Furthermore, there may be a number of accessors, such as accessor 68, which have been given location-based access rights by the administrator 30 to any number of these accessed devices. Once the access control record has been updated with the location-based access rights of the accessor 68, the server computer 12 may update the accessor record of the accessor 68 to include a record link that points to the location-based access rights in the access control record of the accessed device 72.

Next, an accessor log-in is performed (procedure 404). During the accessor log-in, the accessor 68 may input a username and password. The username and password are then transmitted by the accessor device 70 to the server computer 12. If the appropriate username and password have been entered, the accessor 68 may be provided with access to the accessor account. Furthermore, the client application (i.e. either the client application 48 or 50 shown in FIG. 1) may be initiated so as to begin reporting location data identifying the location of the accessor device 70 to the server computer 12. The server computer 12 can use the record links within the accessor record of the accessor 68 to find the location-based access rights of the accessor to what may be various accessed devices, such as accessed device 72. When the location data of the accessor device 70 indicates that the location of the accessor device 70 complies with the location criterion defined by the location-based access rights of the accessed device 72, the accessor device 70 is provided access to the accessed device 72 through the network 16 (shown in FIG. 1).

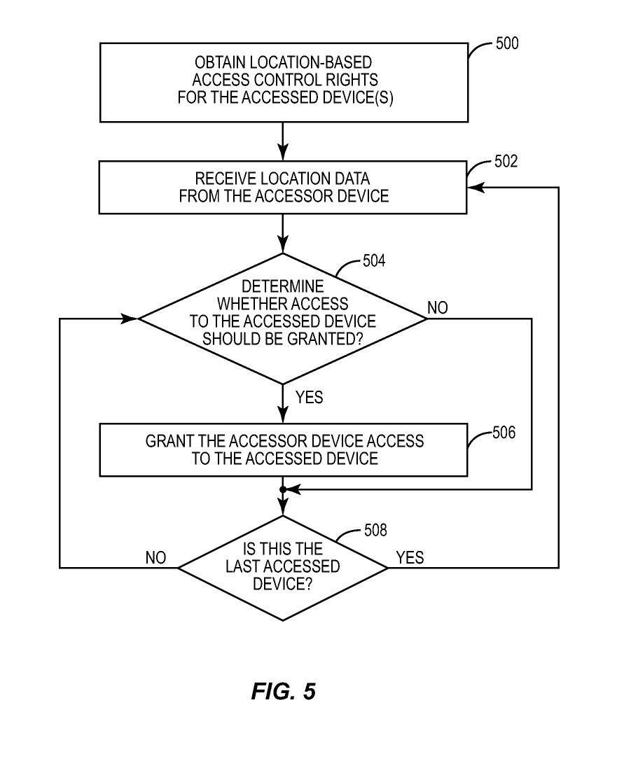

Referring now to FIGS. 1 and 5, FIG. 5 illustrates one embodiment of exemplary procedures for providing the accessor 32, 34 with access to one or more accessed devices 20, 24. The exemplary procedures described for FIG. 5 may include various embodiments of procedure 200, procedure 202, procedure 204, and procedure 206 discussed above for FIG. 2. Further, in this embodiment, it is assumed that the administrator 30 has created location-based access control rights for the accessor 34 to both the accessed device 20 and the location-enabled accessed device 24. It should be noted that the procedures may be equally applicable to the accessor 32 with respect to the accessed device 20 and the location-enabled accessed device 24. In addition, the administrator 30 and the accessor 34 are assumed to have logged into the server computer 12.

To begin, the server computer 12 may obtain the location-based access control rights of the accessor 34 to the accessed device 20 and the location-based access control rights of the accessor 34 to the location-enabled accessed device 24 (procedure 500). Next, the server computer 12 receives location data from the accessor device 28 (procedure 502). The location data identifies the location of the accessor device 28. The accessor device 28 is assigned to the accessor 34 and, as a result, the location of the accessor device 28 is considered to be the location of the accessor 34.

Next, the server computer 12 determines whether access to the accessed device 20 should be granted (procedure 504). This is determined using the location-based access control rights of the accessor 34 to the accessed device 20. If the location of the accessor device 28 complies with the location criteria defined by the location-based access control rights of the accessor 34 to the accessed device 20, access to the accessed device 20 should be granted. On the other hand, if the location of the accessor device 28 does not comply with the location criteria, the accessor device 28 should not be granted access to the accessed device 20. In other embodiments, the location of the accessor device 28 only needs to comply with a subset of the location criteria in order to be granted access to the accessed device 20. Thus, there may be configurations in which the administrator 30 has different location based access control rights depending on the particular identity of the accessor 34.

In some embodiments, the one or more location criterion defined by the location-based access control rights include one or more geographic restrictions that describe a geographic access area. The location of the accessor 34 complies with the geographic restrictions once the location of the accessor 34 is within the geographic access area. When the accessor 34 is logged into the server computer 12 with the accessor device 28, the location of the accessor device 28 is the location of the accessor 34. The server computer 12 is configured to determine whether the location identified by the location data from the accessor device 34 complies with the geographic restrictions such that the location of the accessor device 28 complies with the geographic restrictions once the location identified by the location data from the accessor device 28 is within the geographic access area.

For example, the accessed device 20 is located at the locale 22. To determine whether the accessed device complies with the at least one location criterion, the server computer 12 may obtain location data identifying a location of the locale 22. In this manner, the location of the locale and the geographic restrictions define the geographic access area as encompassing the location of the locale 22. The server computer 12 is configured to determine whether the location identified by the location data from the accessor device 28 complies with the geographic restrictions such that the location of the accessor device 28 complies with the geographic restrictions once the location identified by the location data from the accessor device 28 is within the geographic access area. In this manner, the accessor 34 is close to or within the locale 22 when the location of the accessor 34 complies with the geographic restrictions. The geographic restrictions may be geographic perimeter restrictions that describe the geographic access area as having a symmetrical or unsymmetrical geographic shape. The simplest geographic restriction may be a single geographic restriction that provides a maximum radial distance restriction, which describes a circular geographic access area. However, as previously mentioned, the geographic restrictions may include sets of geographic perimeter restrictions that describe the geographic access area as having any type of symmetrical or unsymmetrical geographic shape.

Next, if access should be granted to the accessor device 28, the server computer 12 grants the accessor device 28 access to the accessed device 20 (procedure 506). On the other hand, if it has been determined that the accessor device 28 should not be granted access to the accessed device 20 or after the server computer 12 has granted the accessor device 28 access to the accessed device 20, the server computer 12 checks to see if this is the last of the accessed devices (procedure 508). In this example, there is another accessed device which is the location-enabled accessed device 24.

The server computer 12 then determines whether access to the location-enabled accessed device 24 should be granted (procedure 504). This is determined using the location-based access control rights of the accessor 34 to the location-enabled accessed device 24. Embodiments of the location-based access control rights of the accessor 34 to the location-enabled accessed device 24 may also include one or more geographic restrictions that define a geographic access area. The server computer 12 obtains location data identifying a location of the location-enabled accessed device 24. As a result, the location of the location-enabled accessed device 24 and the geographic restrictions define the geographic access area as encompassing the location of the location-enabled accessed device 24. The server computer 12 may be configured to determine whether the location of the accessor device 28 complies with the geographic restriction(s) once the location identified by the location data of the accessor device 28 is within the geographic access area. In this manner, the accessor 34 is close to the location-enabled accessed device 24 when the location of the accessor 34 complies with the geographic restrictions.

If the location of the accessor device 28 is within the geographic access area, the accessor device 28 is granted access to the location-enabled accessed device 24 (procedure 506). For example, if the location-enabled accessed device 24 is a vehicle security system, a geographic restriction may include a maximum radial distance restriction or some other set of geographic perimeter restrictions. The geographic access area may thus encompass the location of the vehicle security system based on the radial distance parameter and location data identifying the location of the vehicle security system. If the location data identifying the location of the accessor device 28 indicates that the accessor 34 is within the maximum radial distance indicated by the maximum radial distance restriction of the vehicle security system, the accessor 34 is granted access to the vehicle security system.

After the accessor device 28 has been granted access to the location-enabled accessed device 24 or if it was determined that the location of the accessor device 28 did not comply with the geographic restrictions, the server computer 12 again checks whether this is the last accessed device (procedure 508). Procedures 502, 504, 506, and 508 may again be repeated for each accessed device 20, 24.

For example, the location data of the accessor device 28 may again be received by the server computer 12 so that the location of the accessor device 28 identified by the location data is updated (procedure 502). Next, it is again determined whether access to the accessed device 20 should be granted (procedure 504). Embodiments of the server computer 12 may again determine whether the location identified by the location data from the accessor device 28 complies with the geographic restrictions after the location of the accessor device identified by the location data from the accessor device 28 has been updated. With regards to the previous example provided where the location of the locale 22 and the geographic restrictions define the geographic access area, the server computer 12 may again determine whether the location identified by the location data from the accessor device 28 complies with the geographic restrictions after the location of the accessor device 28 has been updated. If access has not previously been granted and access should now be granted, the server computer 12 grants the accessor device 28 access to the accessed device 20 (procedure 506). After access is granted or if it was again determined that access should not be granted, the server computer 12 again implements procedure 508. In procedure 508, it is determined whether there is another accessed device. As discussed previously, in this embodiment there is another accessed device, namely, the location-enabled accessed device 24.

Next, the server computer 12 again determines whether access to the location-enabled accessed device 24 should be granted (procedure 504). Since the location-enabled accessed device 24 may have moved, the server computer 12 may again, obtain the location data identifying the location of the location-enabled accessed device 24 so that the location of the location-enabled accessed device 24 identified by the location data from the location-enabled accessed device 24 is updated. In one embodiment the server computer 12 again determines whether the location identified by the location data from the accessor device complies with the geographic restrictions after the location of the location-enabled accessed device 24 identified by the location data from the location-enabled accessed device 24 has been updated and after the location of the accessor device 28 identified by the location data from accessor device has been updated. In this manner, the server computer 12 can determine whether to grant the accessor device 28 access to the location-enabled accessed device 24 regardless of whether the location-enabled accessed device 24 is moved. With respect to the above mentioned example regarding the vehicle security system, if the vehicle is moved to another location, the geographic access area follows the vehicle security system.

If it has not been previously granted but should now be granted, the server computer 12 grants access to the location-enabled accessed device 24 (procedure 506). After access is granted or if it was determined that access should not be granted, the server computer 12 again implements procedure 508. If there are no more accessed devices, the server computer 12 may then loop back to procedure 502.

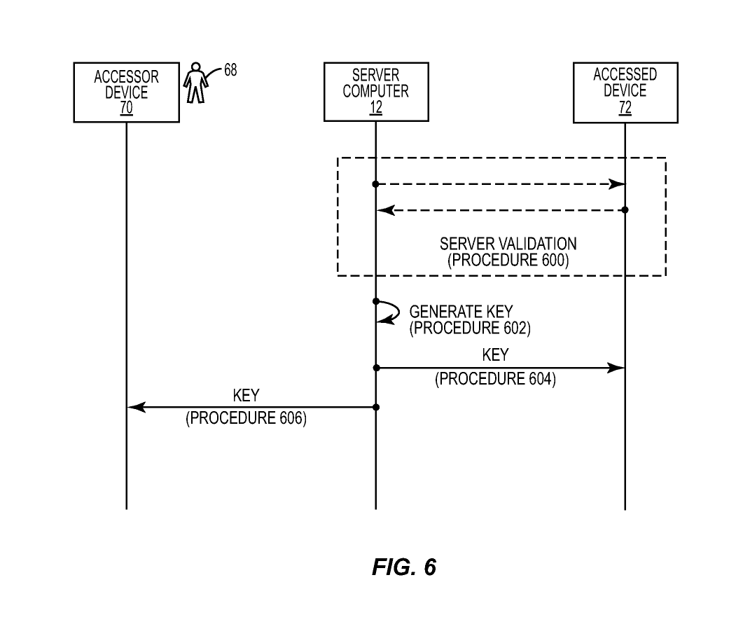

Referring now to FIG. 6, FIG. 6 is a flow diagram illustrating one embodiment of exemplary procedures for granting the accessor device 70 with access to the accessed device 72 through the network 16 (shown in FIG. 1). In response to determining that the location of the accessor device 70 complies with the at least one location criterion defined by the location-based access control rights of the accessor 68 to the accessed device 72, the server computer implements server validation (procedure 600). This may involve handshaking between the server computer 12 and the accessed device 72 along with procedures that validate to the accessed device 72 that the server computer 12 is not an eavesdropper. After server validation, the server computer 12 may generate a key (procedure 602). This key may be any type of information that secures communications between devices such as a hash key, a security token, and/or the like. The key is then sent to the accessed device 72 by the server computer 12 through the network 16 (procedure 604). In addition, the key required to access the accessed device 72 is sent to the accessor device 70 by the server computer 12 through the network 16 (procedure 606). The accessor device 70 may then utilize the key to communicate with the accessed device 72.

In this embodiment, the accessor device 70 and the accessed device 72 may communicate directly with one another using the key without the server computer 12 serving as an intermediary node between the accessor device 70 and the accessed device 72. For instance, the accessor device 70 may establish a wireless local area networking link, such as a personal area networking link, using the key so that the accessor device 70 can send commands to the accessed device 72. It should be noted that the key may include the access permissions from the location-based access control rights of the accessor 68 to the accessed device 72. Consequently, the key may provide access to only certain operational functions provided by the accessed device 72, and/or may be valid for a defined time period.

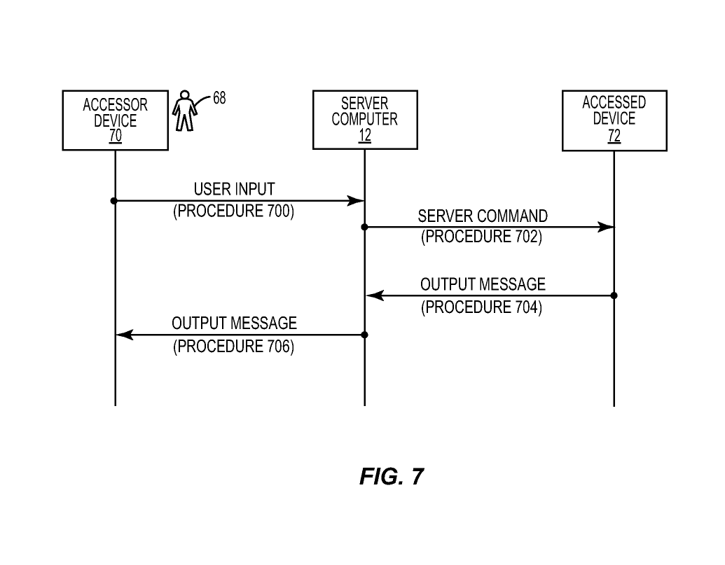

FIG. 7 is a flow diagram illustrating exemplary procedures of another embodiment in which the server computer 12 grants the accessor device 70 access to the accessed device 72. The accessed device 72 is operable to provide at least one operational function. In addition, the accessed device 72 is configured to implement the operational function in response to a server command for the server computer 12. In FIG. 7, the server computer 12 grants access to the accessor device 70 by serving as an intermediary node between the accessor device 70 and the accessed device 72. Since the accessor 68 has logged into the server computer 12, the server computer 12 has previously validated the accessor 68 using the accessor device 70. The server computer 12 may also be able to engage in validation procedures with accessed device 72 or the accessed device 72 may simply be configured to have an exclusive or semi-exclusive network-enabled connection with the server computer 12. Upon determining that the location of the accessor device 70 complies with one or more location criterion defined by the location-based access control rights of the accessor 68 to the accessed device 72, the accessor device 70 may present the accessor 68 with icons that allow the accessor 68 to select operational functions to be implemented by the accessed device 72. Through selection by the accessor 68, user input is obtained by the accessor device 70 (procedure 700). This user input indicates a selection of an operational function. The server computer 12 then receives the user input through the network 16.

Next, the server computer 12 may then determine the appropriate server command or server commands needed in order for the accessed device 72 to implement the desired operational function. The server command is then transmitted by the server computer 12 through the network 16 to the accessed device in response to receiving the user input (procedure 702). Once the accessed device 72 receives the server command, the accessed device 72 implements the operational function. For example, the server computer 12 may transmit a command to disable an alarm through the network 16 when the accessed device 72 is a home security system or a vehicle security system. In another example, the server computer 12 may transmit a command that grants limited access to a personal computer or a cable television box.

The accessed device 72 may then transmit an output message to the server computer 12 (procedure 704). The output message includes information and output data resulting from the implementation of the operational function. The server computer 12 may then relay the output message to the accessor device 70 (procedure 706).

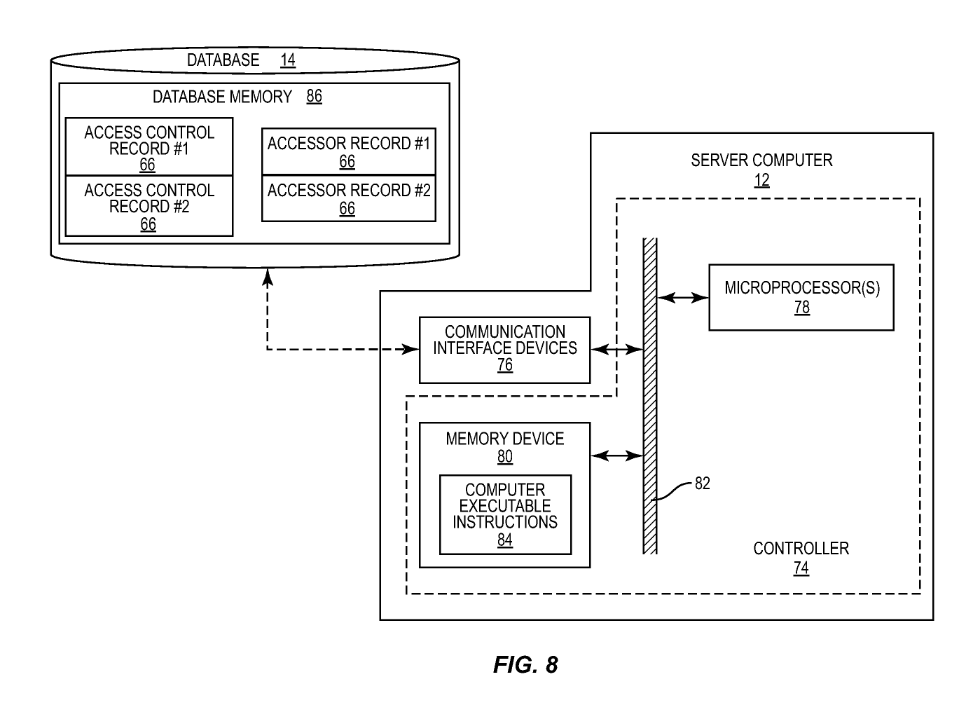

FIG. 8 illustrates one embodiment of the server computer 12 (shown in FIG. 1). The server computer 12 includes a controller 74 and communication interface devices 76. Also shown is one embodiment of the database 14 shown in FIG. 1 connected to the server computer 12 through the communication interface devices 76. The communication interface devices 76 may also be operable to communicatively couple the server computer 12 to the network 16. As discussed above, the network 16 may include various different types of networks. The communication interface devices 76 may be adapted to facilitate communications with one or more communication services on different types of networks. In this example, the communication interface devices 76 facilitates communications for any number of communications provided by mobile communications networks, packet switch networks, circuit switch networks, and/or the like. Note that the server computer 12 may be equipped with two or more communication interface devices 76, for example, one to communicatively couple the server computer 12 to a public network and one to connect the server computer 12 to the database 14 over, for example, a private high speed LAN.

In this embodiment, the controller 74 has general purpose computer hardware, in this case one or more microprocessors 78 and a non-transitory computer readable media, such as a memory device 80. The controller 74 may also include other hardware such as a system bus 82, control logic, other processing devices, additional non-transitory computer readable mediums, and the like. User input and output devices (not shown), such as monitors, keyboards, mouse, touch screens, and the like may also be provided to receive input and output information from a manager of the server computer 12. The memory device 80 may store computer executable instructions 84 for the microprocessors 78. The computer executable instructions 84 may configure the operation of the microprocessors 78 so that the microprocessors 78 implement the software applications of the server computer 12 discussed above. The system bus 82 is operably associated with the microprocessors 78, the memory device 80, the communication interface devices 76, and other hardware components internal to the server computer 12, so as to facilitate communications between these devices.

The database 14 includes database memory 86 that stores the database records 66. In this example, the database records include access control record #1 and access control record #2 for the accessed device 20 and the location-enabled accessed device 24, which may be stored under the administrator account of administrator 30. Also shown is accessor record #1, which may be stored under the accessor account of the accessor 26, and accessor record #2, which may be stored under the accessor account of the accessor 28, respectively. The database 14 may also store additional information, such as database tables in local memory. Furthermore, the database 14 may include additional programmed hardware components (not shown) that allow the creation, organization, retrieving, retrievable, updating, and/or storage of the database records 66.

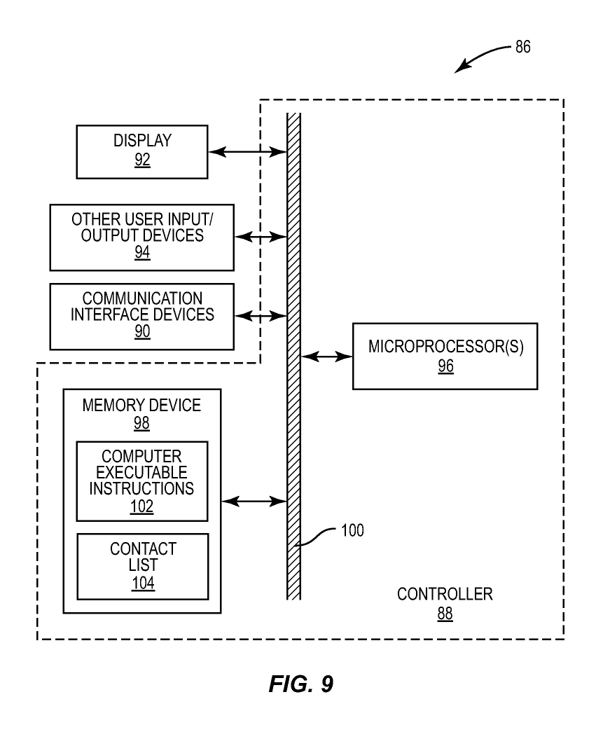

Referring now to FIG. 9, FIG. 9 illustrates one embodiment of a user device 86 which may be any one of the administrator device 18, the accessed device 20, the location-enabled accessed device 24, the accessor device 26, and/or the accessor device 28. The user device 86 may include a controller 88, communication interface devices 90, a display 92, and other user input and output devices 94. The communication interface devices 90 are operable to communicatively couple the user device 86 to the network 16. As discussed above, the network 16 may include various different types of mobile communications networks, packet switch networks, and circuit switch networks. The communication interface devices 90 may be adapted to facilitate communications with one or more communication services on the network 16.

Next, the controller 88 has general purpose computer hardware, which in this case is one or more microprocessors 96, a non-transitory computer readable medium, such as a memory device 98, and a system bus 100. The system bus 100 is operably associated with the microprocessors 96, memory device 98, the communication interface devices 90, the display 92, the other user input and output devices 94, and other devices internal to the user device 86, so as to facilitate communications between the devices. The controller 88 may include other hardware such as control logic, other processing devices, additional non-transitory computer readable mediums, and the like. The memory device 98 may store computer executable instructions 102. The computer executable instructions 102 configure the operation of the microprocessors 96 so that the microprocessors 96 implement the software applications of either the administrator device 18, the accessed device 20, the location-enabled accessed device 24, the accessor device 26, or the accessor device 28, as discussed above. The memory device 98 may also store a local copy of a contact list 104. Display 92 may be any suitable display for a user device 86. For example, the display 92 may be a touch screen, monitor, LCD display, plasma display, and/or the like. The other user input and output devices 94 may be a keyboard, a microphone, a headset, a mouse, and/or an input or output button, and may depend on the particular configuration of the user device 86.

Those skilled in the art will recognize improvements and modifications to the preferred embodiments of the present disclosure. All such improvements and modifications are considered within the scope of the concepts disclosed herein and the claims that follow.

What is claimed is:

1. A method of providing an accessor with access to an accessed device through a network, comprising:
obtaining location-based access control rights of the accessor to the accessed device, wherein the location-based access control rights define at least one location criterion such that access rights are to be granted to the accessor for the accessed device when a location of the accessor complies with one or more of the at least one location criterion;
obtaining location data that identifies the location of an accessor device assigned to the accessor;
determining, by a server computer on the network, whether the location of the accessor device complies with the one or more of the at least one location criterion based on the location data; and
upon determining that the location of the accessor device complies with the one or more of the at least one location criterion, granting the accessor device access to the accessed device through the network.

2. The method of claim 1, wherein the accessed device is operable to implement a plurality of operational functions and the location-based access control rights further define one or more access permissions that provide access to a subset of one or more of the plurality of the operational functions.

3. The method of claim 2, wherein granting the accessor device access to the accessed device through the network is in accordance with the one or more access permissions so that the accessor device can access only the subset of one or more of the plurality of the operational functions.

4. The method of claim 1, wherein the location-based access control rights further define one or more access permissions that define a time period which temporally limits the access rights of the accessor to the accessed device.

5. The method of claim 4, wherein granting the accessor device access to the accessed device through the network is only for a duration of the time period.

6. The method of claim 1, wherein the one or more of the at least one location criterion defined by the location-based access control rights comprise one or more geographic restrictions for describing a geographic access area such that the location of the accessor complies with the one or more geographic restrictions once the location of the accessor is within the geographic access area.

7. The method of claim 6, wherein determining whether the location of the accessor device complies with the one or more of the at least one location criterion comprises:
determining whether the location identified by the location data from the accessor device complies with the one or more geographic restrictions such that the location identified by the location data complies with the geographic restrictions when the accessor device is within the geographic access area.

8. The method of claim 7, if the location of the accessor device is not determined to comply with the one or more of the at least one location criterion, the method further comprising:
again, obtaining the location data so that the location of the accessor device identified by the location data is updated; and
again, determining whether the location identified by the location data from the accessor device complies with the one or more geographic restrictions after the location of the accessor device identified by the location data has been updated.

9. The method of claim 6, wherein the accessed device is located at a locale and wherein determining whether the location of the accessor device complies with the one or more of the at least one location criterion comprises:
obtaining location data identifying a location of the locale so that the location of the locale and the one or more geographic restrictions define the geographic access area as encompassing the location of the locale;
determining whether the location identified by the location data from the accessor device complies with the one or more geographic restrictions such that the location of the accessor device complies with the one or more geographic restrictions once the accessor device is within the geographic access area.

10. The method of claim 9, wherein, if the location of the accessor device is not determined to comply with the one or more of the at least one location criterion, the method further comprises:
again, obtaining the location data of the accessor device so that the location of the accessor device identified by the location data from the accessor device is updated; and
again, determining whether the location identified by the location data from the accessor device complies with the one or more geographic restrictions after the location of the accessor device identified by the location data from the accessor device has been updated.

11. The method of claim 6, wherein the accessed device is a location-enabled accessed device and wherein determining whether the location of the accessor device complies with the one or more of the at least one location criterion comprises:
obtaining location data identifying a location of the location-enabled accessed device so that the location of the location-enabled accessed device and the one or more geographic restrictions define the geographic access area as encompassing the location of the location-enabled accessed device; and
determining whether the location identified by the location data from the accessor device complies with the one or more geographic restrictions such that the location of the accessor device complies with the one or more geographic restrictions once the location of the accessor device is within the geographic access area.

12. The method of claim 11, if the location of the accessor device is not within the access area, the method further comprises:
again, obtaining the location data identifying the location of the accessor device so that the location of the accessor device identified by the location data from the accessor device is updated;
again, obtaining the location data identifying the location of the location-enabled accessed device so that the location of the location-enabled accessed device identified by the location data from the location-enabled accessed device is updated wherein the location of the location-enabled accessed device and the one or more geographic restrictions define the geographic access area as encompassing the location of the location-enabled accessed device after the location identified by the location data from the location-enabled access device has been updated; and
again, determining whether the location identified by the location data from the accessor device complies with the one or more geographic restrictions, after the location of the location-enabled accessed device identified by the location data from the location-enabled accessed device has been updated, and, after the location of the accessor device identified by the location data from the accessor device has been updated.

13. The method of claim 1, wherein granting the accessor device access to the accessed device through the network comprises:
sending, by the server computer through the network, a key to the accessor device which is required to access the accessed device.

14. The method of claim 13, wherein granting the accessor device access to the accessed device through the network further comprises:
sending, by the server computer through the network, the key to the accessed device.

15. The method of claim 1, wherein the accessed device is operable to provide an operational function and the accessed device is configured to implement the operational function in response to a server command from the server computer, and wherein granting the accessor device access to the accessed device through the network comprises:
receiving, by the server computer through the network, user input from the accessor device wherein the user input indicates a selection of the operational function; and
transmitting, by the server computer through the network, the server command to the accessed device in response to receiving the user input.

16. A server computer operable to provide an accessor with access to an accessed device through a network, comprising:
at least one communication interface device that is configured to communicatively couple the server computer with the network; and
a controller operably associated with the at least one communication interface device and configured to:
obtain location-based access control rights of the accessor to the accessed device, wherein the location-based access control rights define at least one location criterion such that access rights are to be granted to the accessor for the accessed device when a location of the accessor satisfies one or more of the at least one location criterion;
obtain location data that identifies the location of an accessor device assigned to the accessor;
determine whether the location of the accessor device complies with the one or more of the at least one location criterion based on the location data; and
upon determining that the location of the accessor device complies with the one or more of the at least one location criterion, grant the accessor device access to the accessed device through the network.

17. The server computer of claim 16, wherein the accessed device is operable to implement a plurality of operational functions and the location-based access control rights further define one or more access permissions that provide access to a subset of one or more of the plurality of the operational functions.

18. The server computer of claim 17, wherein the server computer is configured to grant the accessor device access to the accessed device through the network in accordance to the one or more access permissions so that the accessor device can access only the subset of one or more of the plurality of the operational functions.

19. The server computer of claim 16, wherein the server computer is configured to grant the accessor device access to the accessed device through the network by:
sending a key to the accessor device through the network, wherein the key is required to access the accessed device.

20. The server computer of claim 16, wherein the accessed device is operable to provide an operational function and the accessed device is configured to implement the operational function in response to a server command from the server computer and wherein the server computer is configured to grant the accessor device access to the accessed device through the network by:
receiving user input from the accessor device through the network wherein the user input indicates a selection of the operational function; and
transmitting the server command to the accessed device through the network in response to receiving the user input.
